(19) United States
(12) Patent Application Publication
(10) Pub. No.: US 2007/0014364 A1
(43) Pub. Date: Jan. 18, 2007

(54) Video coding method for performing rate control through frame dropping and frame composition, video encoder and transcoder using the same

(75) Inventor: Sihn Kue-hwan, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/476,081

(22) Filed: Jun. 28, 2006

(30) Foreign Application Priority Data
Jul. 16, 2005 (KR) 10-2005-0064542

(51) Int. Cl. H04N 11/02; H04N 11/04; H04N 7/12

(52) U.S. Cl. 375/240.16; 375/240.18; 375/240.26

(57) ABSTRACT

A video coding method and apparatus that can allocate bits more efficiently when encoding or transcoding a moving frame is disclosed. The video coding method includes determining a frame to be dropped among a plurality of frames, generating a composite frame by obtaining a weighted sum of a frame adjacent to the frame to be dropped and the frame to be dropped, and generating a bitstream by encoding the generated composite frame.

### CROSS-REFERENCE TO RELATED APPLICATION

This application claims priority from Korean Patent Application No. 10-2005-0064542 filed on Jul. 16, 2005 in the Korean Intellectual Property Office, the disclosure of which is incorporated herein by reference in its entirety.

### BACKGROUND OF THE INVENTION

1. Field of the Invention

Methods and apparatuses consistent with the present invention relate to video coding, and more particularly, to a rate control method and apparatus that can allocate bits more efficiently when encoding or decoding a moving frame

2. Description of the Prior Art

With the development of information and communication technologies including the Internet, multimedia communications are increasing in addition to text and voice communications. The existing text-centered communication systems are insufficient to satisfy consumers' diverse desires, and thus multimedia services that can accommodate diverse forms of information such as text, image, music and others are increasing. Since multimedia data is large, mass storage media and wide bandwidths are respectively required for storing and transmitting it. For example, a 24-bit true color image having a 640×480 resolution requires a data capacity of 640×480×24 bits, i.e., 7.37 Mbits per frame. In the case of transmitting data at 30 frames per second, a bandwidth of about 221 Mbits/sec is required, and in the case of storing a 90 min. movie, a storage space of about 1,200 Gbits is required. Accordingly, compression coding techniques are required to transmit the multimedia data.

The basic principle of data compression is to remove data redundancy. Data can be compressed by removing spatial redundancy such as a repetition of the same color or object in images, temporal redundancy such as similar adjacent frames in moving images or continuous repetition of sounds, and visual/perceptual redundancy, which considers human insensitivity to high frequencies. Data compression can be divided into lossy/lossless compression, intraframe/interframe compression, and symmetric/asymmetric compression depending on whether source data is lost, whether compression is independently performed for respective frames, and whether the same time is required for compression and decompression, respectively. In addition, if the compression/decompression delay time does not exceed 50 ms, the corresponding compression is classified into real-time compression, and if frames have diverse resolutions, the corresponding compression is classified into a scalable compression. In the case of text or medical data, lossless compression is used, and in the case of multimedia data, lossy compression is mainly used. In order to remove the spatial redundancy, intraframe compression is used, and in order to remove the temporal redundancy, interframe compression is used.

However, if the bandwidth of a network for transmitting a bitstream is insufficient or an appliance for decoding the bitstream is limited, the size of the bitstream should be smaller, and the compression technique alone may not be able to supply the bitstream.

Accordingly, a conventional video encoder or decoder predicts motion, transforms a frame, and performs bit-rate control when generating a compressed bitstream. This bit-rate control is mostly performed for a group of pictures (GOP). In the moving picture expert group (MPEG)-series moving frame compression method, different types of frames, such as I-frame, P-frame and B-frame, exist in a GOP according to prediction methods. Generally, the sizes of these frames differ.

In the MPEG-series moving frame compression method, different numbers of bits are required depending on the frame types as shown in FIG. 1. Particularly, the I-frame, which can be played without any reference frame, requires a large number of bits, the P-frame, which is composed of a part of difference obtained by unidirectionally referring to the I-frame or another P-frame, requires a lesser number of bits, and the B-frame, which is composed of a part of difference obtained by bidirectionally referring to the I-frame or the P-frame, requires the least number of bits. In addition to such variation of the required number of bits according to the frame type, the optimized number of bits required for each GOP greatly differs according to the complexity of the scene or the speed of movement.

In particular, a variable bit-rate (VBR) source, which has a severe variation of bit rate, such as a DVD, is not suitable for network streaming. FIG. 2 is a view illustrating the variation of the bit rate of a GOP unit of a DVD. As shown in FIG. 2, the average bit rate of the GOP unit varies abruptly in the range of 3.5 Mbps to 9 Mbps. If the VBR source data is streamed over the network as it is, a buffer underrun may occur in the sequence having a high bit rate because the source data cannot reach the video decoder in time. This makes it difficult to obtain a seamless video.

By contrast, if the bandwidth of the network is set based on the maximum bit rate of the VBR video source, network resources could be wasted in proportion to the difference between the maximum bit rate and the average bit rate. Furthermore, if the available bandwidth of the network is changed, it may be difficult to transmit the given VBR source data.

In order to transmit video data over a network, video data is compressed in advance so that it has a constant bit rate (CBR), VBR data is transformed (i.e., transcoded) into CBR data. If the available bandwidth of the network is changed, the CBR would be a piecewise CBR.

As described above, according to the conventional method, it is difficult to allocate sufficient bits to the I-frame in a complicated scene that requires a large amount of bits due to the CBR characteristic that should match the bit rate with the available bandwidth, and thus the frame quality of the frames affected by the I-frame (e.g., the P-frames and B-frames in the same GOP) deteriorates. By contrast, if too many bits are allocated to the I-frames, the B-frames and the P-frames will be allocated too few bits, and this causes a similar deterioration of the video quality.

In other words, it is difficult to escape the variation of the bit rate, and it is difficult to escape the deterioration of the video quality required to maintain a constant bit rate. In order to solve this problem, Japanese Patent Unexamined Publication No. 2004-158929 discloses a method of reducing the amount of data by intentionally dropping part of the B-frames when the bit budget is considerably insufficient. However, if part of the frames are dropped, this causes a significant deterioration in the objective video quality.

### SUMMARY OF THE INVENTION

Accordingly, the present invention has been made to address the above-mentioned problems occurring in the prior art, and an aspect of the present invention is to provide a method and apparatus that can prevent the deterioration of subjective video quality as well as it reduces an amount of video data being transmitted.

Additional aspects and features of the invention will be set forth in part in the description which follows and in part will become apparent to those having ordinary skill in the art upon examination of the following or may be learned from practice of the invention.

In order to accomplish these objects, there is provided a video coding method, according to the present invention, which includes operations of (a) determining at least one frame to be dropped among a plurality of frames; (b) generating a composite frame by obtaining a weighted sum of a frame adjacent to the at least one frame to be dropped and the at least one frame to be dropped; and (c) generating a bitstream by encoding the generated composite frame.

In another aspect of the present invention, there is provided a video transcoding method, which includes operations of (a) decoding an input bitstream; (b) determining at least one frame to be dropped among a plurality of frames generated as a result of the decoding; (c) generating a composite frame by obtaining a weighted sum of a frame adjacent to the at least one frame to be dropped and the at least one frame to be dropped; and (d) generating another bitstream by encoding the generated composite frame.

In still another aspect of the present invention, there is provided a video encoder, which includes a unit which determines at least one frame to be dropped among a plurality of frames; a unit which generates a composite frame by obtaining a weighted sum of a frame adjacent to the at least one frame to be dropped and the at least one frame to be dropped; and a unit which generates a bitstream by encoding the generated composite frame.

In still another aspect of the present invention, there is provided a video transcoder, which includes a unit which decodes an input bitstream; a unit which determines at least one frame to be dropped among a plurality of frames generated as a result of the decoding; a unit which generates a composite frame by obtaining a weighted sum of a frame adjacent to the at least one frame to be dropped and the at least one frame to be dropped; and a unit which generates another bitstream by encoding the generated composite frame.

### BRIEF DESCRIPTION OF THE DRAWINGS

The above and other objects, features and advantages of the present invention will become more apparent from the following detailed description taken in conjunction with the accompanying drawings, in which:

FIG. 1 is a view illustrating bit amounts required for the different frame types;

FIG. 2 is a view illustrating the variation of a bit rate for a GOP unit of one chapter of a DVD;

FIG. 3 is an exemplary view illustrating successive video sequences;

FIG. 4 is an exemplary view illustrating the resultant sequences obtained by applying a conventional frame dropping method to the video sequences of FIG. 3;

FIG. 5 is an exemplary view illustrating the resultant sequences obtained by applying a B-frame composition mode according to an exemplary embodiment of the present invention to the video sequences of FIG. 3;

FIG. 6 is an exemplary view explaining the dropping and composing of B-frames in an environment as illustrated in FIG. 1;

FIG. 7 is a schematic view explaining the concept of alpha blending;

FIG. 8 is a view explaining the basic concept of motion blurring according to an exemplary embodiment of the present invention;

FIG. 9 is a view illustrating a process of adding motion blurring to the alpha blending of FIG. 7 according to an exemplary embodiment of the present invention; and

FIG. 10 is a block diagram illustrating the construction of a video encoder according to an exemplary embodiment of the present invention.

### DETAILED DESCRIPTION OF THE PREFERRED EMBODIMENTS

Hereinafter, exemplary embodiments of the present invention will be described in detail with reference to the accompanying drawings. The aspects and features of the present invention and methods for achieving the aspects and features will be apparent by referring to the exemplary embodiments to be described in detail with reference to the accompanying drawings. However, the present invention is not limited to the exemplary embodiments disclosed hereinafter, but can be implemented in diverse forms. The matters defined in the description, such as the detailed construction and elements, are nothing but specific details provided to assist those of ordinary skill in the art in a comprehensive understanding of the invention, and the present invention is only defined within the scope of the appended claims. In the entire description of the present invention, the same drawing reference numerals are used for the same elements across various figures.

The principal point of the present invention is that, if an I-frame requires more bits when a transcoder or an encoder generates a new moving picture bitstream at a constant bit rate (CBR), the encoder or the transcoder can provide the remaining bits obtained by deleting a part of B-frames to the I-frame. Since the video may seem unnatural if B-frames are simply dropped, the part of the B-frame to be dropped and the remaining B-frame are used.

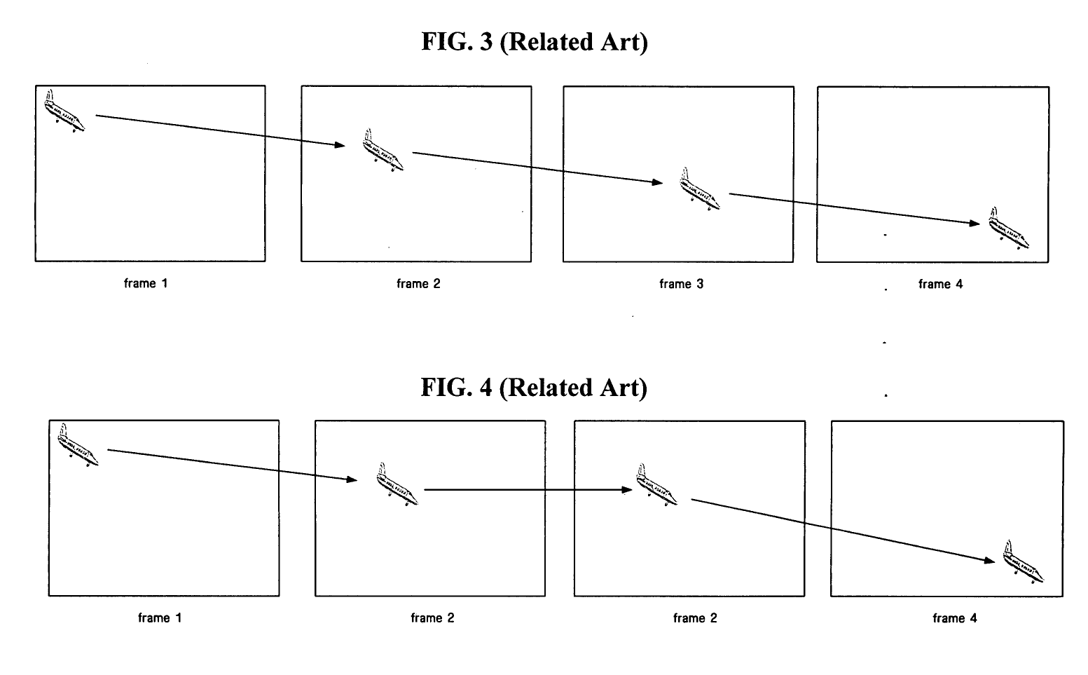

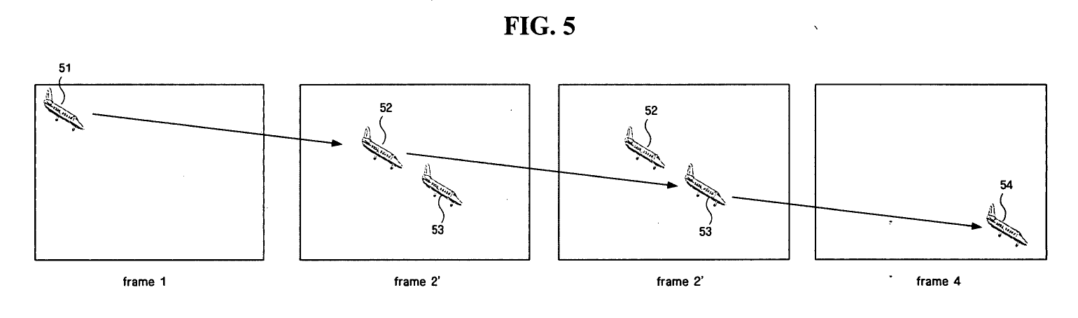

If it is assumed that successive video sequences as shown in FIG. 3 exist, the sequences that are displayed according to the conventional frame dropping method may be as illustrated in FIG. 4, and the sequences that are displayed according to a B-frame composition mode proposed according to an exemplary embodiment of the present invention may be as illustrated in FIG. 5.

As shown in FIG. 4, the conventional frame dropping method drops a frame (e.g., frame 3), and continuously displays the previous frame (e.g., frame 2). Thus, the user observes the previous frame (e.g., frame 2) and it appears to the user that the motion has stopped for a moment, and then the next frame (e.g., frame 4) having a large, abrupt motion is observed, and this causes the subjective frame quality to deteriorate.

By contrast, according to an exemplary embodiment of the present invention as shown in FIG. 5, a frame (e.g., frame 3) is dropped in the same manner, but a composite frame (e.g., frame 2′) is produced by weight-adding the dropped frame and the frame just before the dropped frame, which is different from the conventional frame dropping method. Since frame 2′ includes both the image of frame 2 and the image of frame 3, the user can view a more natural video than that produced by the conventional frame dropping method.

Specifically, the user recognizes the movement between the initial moving object 51 and the last moving object 54 as continuous movement. Accordingly, although frame 2′ includes two moving objects 52 and 53, the user turns his/her attention to the moving object 52 when frame 2′ is first displayed, and then the user turns his/her attention to the moving object 53. when frame 2′ is displayed again. This improves the subjective video quality.

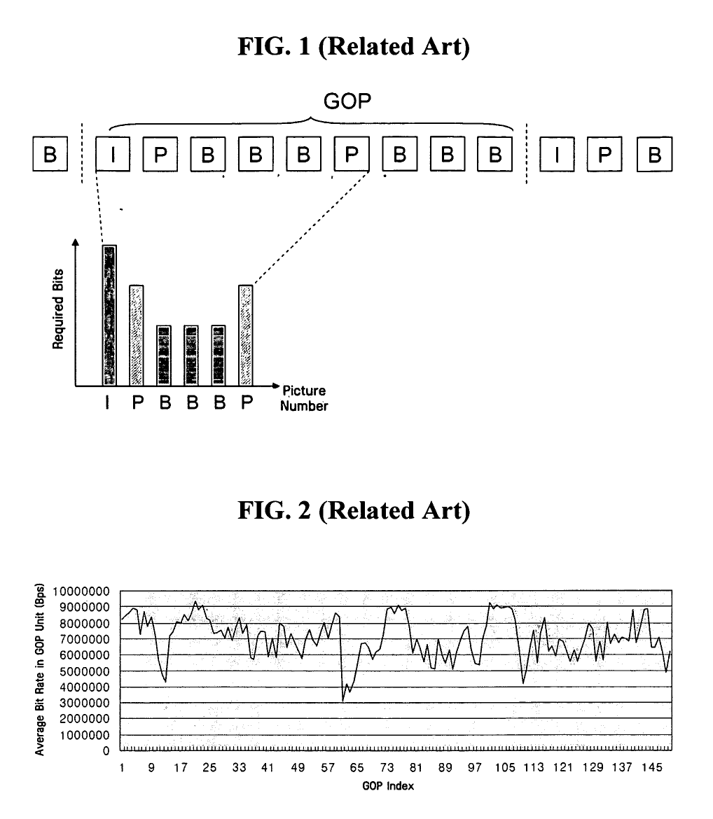

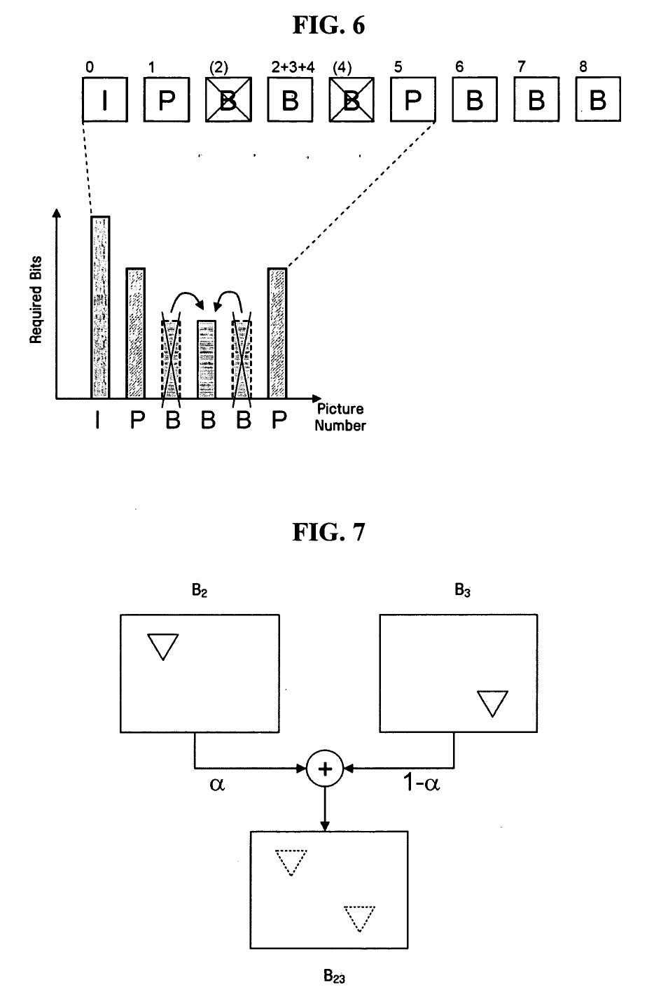

FIG. 6 is an exemplary view explaining dropping and composing B-frames in an environment as illustrated in FIG. 1. As shown in FIG. 6, two B-frames among three successive B-frames are dropped. In this case, it is preferable, but not necessary, to drop the left and right B-frames while retaining the center B-frame. The two dropped B-frames and the remaining B-frame are composed. Two or more B-frames may be composed as needed.

Hereinafter, a process for performing a B-frame composition according to an exemplary embodiment of the present invention will be explained. Specifically, the process may briefly include a bit-rate comparison operation for determining whether to perform the B-frame composition by comparing the current allowed number of bits with the number of bits already used, a bit reallocation operation for allocating bits of the B-frame to be deleted to another frame, a B-frame composition operation for composing B-frames in neighboring parts, and an overlapping-frame setting operation for inserting a code into the composite B-frame. In the description, the “B-frame” does not simply mean a B-frame that is used in the conventional MPEG-series codec, but means a frame that is not a reference frame for other frames.

A B-frame is dropped or composed because the B-frame is not used to restore other frames in most moving picture standards (in particular, MPEG-2), and therefore the dropping or composition of the B-frame does not affect the frame quality of the following frames. If a P-frame or an I-frame is composed, a large residual may remain in a process of obtaining a residual signal by predicting a frame that refers to the P or I-frame, and this may cause the number of required bits to increase. However, a P-frame, which is confirmed to have a little effect on other frames, and the preceding or following B-frame may be composed.

The four operations described above will be explained in more detail in the following.

Bit-Rate Comparison

In this operation, it is checked whether an encoded GOP is in accord with a target bit rate. In the case of an MPEG-2 TM5 (Test Model 5) encoder, if the encoded frames currently require more bits at a given bit rate, the available bits (R) for the next GOP are given a negative value. In this case, even if a quantization parameter having the largest value is used, i.e., even if the encoding is performed with the lowest frame quality, the generated GOP will exceed the target bit rate. Accordingly, by switching on the B-frame composition mode proposed according to an exemplary embodiment of the present invention, the generated GOP can reach the target bit rate.

In addition, even in the case where an average value of quantization parameters is continuously kept at a considerably large value, the quantization parameter values of the respective frames are lowered using bits secured by switching on the B-frame composition mode, and thus an improved frame quality can be achieved.

Bit Reallocation

The purpose of removing B-frames is to allocate more bits to other frames or to match the target bit rate. If it is assumed that the number of frames owned by one GOP is “N,” and the number of B-frames that are dropped in the GOP is “N_{bx}”, “N−N_{bx}” frames exist in the GOP, and the bits allocated to the GOP can be allocated to the respective frames by a specified bit allocation algorithm. This algorithm may be one of the algorithms specified in the MPEG-2 TM5 encoder or another algorithm.

In the case of an MPEG-2 TM5 encoder, respective target bit values “Tᵢ”, “Tₚ” and “T_{b}” for I, P, and B-frames in the GOP can be calculated by substituting the remaining value, which is obtained by subtracting “N_{bx}” from the number of B-frames “N_{b}”, for “N_{b}”.

B-Frame Composition

A pixel-domain blending method, that can be used in a general encoder and a cascaded pixel-domain transcoder, and a transform-domain blending method, that can be used in a transform-domain transcoder, may be used as a method of composing the B-frame to be dropped and the remaining B-frame.

The pixel-domain blending method is basically performed through a process of obtaining a weighted sum of the frame determined to be dropped and its adjacent frame. The weighted sum can be obtained using YUV components of one frame. A linear blending method such as alpha blending may be used to obtain the weighted sum. Although the alpha (α) value that is used for the alpha blending can be obtained by a more complicated algorithm, it may be simply set to “0.5” to compose two frames.

FIG. 7 is a schematic view explaining the concept of alpha blending. A stationary background in two B-frames B₂ and B₃ is expressed in the same manner in a composite frame B₂₃, and only moving areas appear in the composite frame by reflecting parts of the two B-frames.

A luminance value of the composite frame can be obtained by alpha blending as expressed in Equation (1), and a chroma value of the composite frame can be obtained in the same manner.
B₂₃=α×B₂+(1−α)×B₃ (1)

If it is assumed that two frames B₁ and B₃ are dropped, and then three frames B₁, B₂ and B₃ are composed, the composite frame B₁₂₃ can be obtained by the alpha blending method as expressed in Equation (2).
B₁₂₃=α₁×B₁+α₂×B₂+(1−α₁−α₂)×B₃ (2)

In the case as expressed by Equation (2), the composite frame B₁₂₃ may be obtained by setting the α₁ and α₂ to “⅓” (i.e., by applying the same weight).

The B-frame composition operation as described above may be performed at the encoder end or the transcoder end. In the case where the B-frame composition operation is performed by the encoder, the frames B₁, B₂, and B₃ are the original B-frames to be encoded. In the case where the B-frame composition operation is performed by the transcoder, the frames B₁, B₂, and B₃ are decoded B-frames.

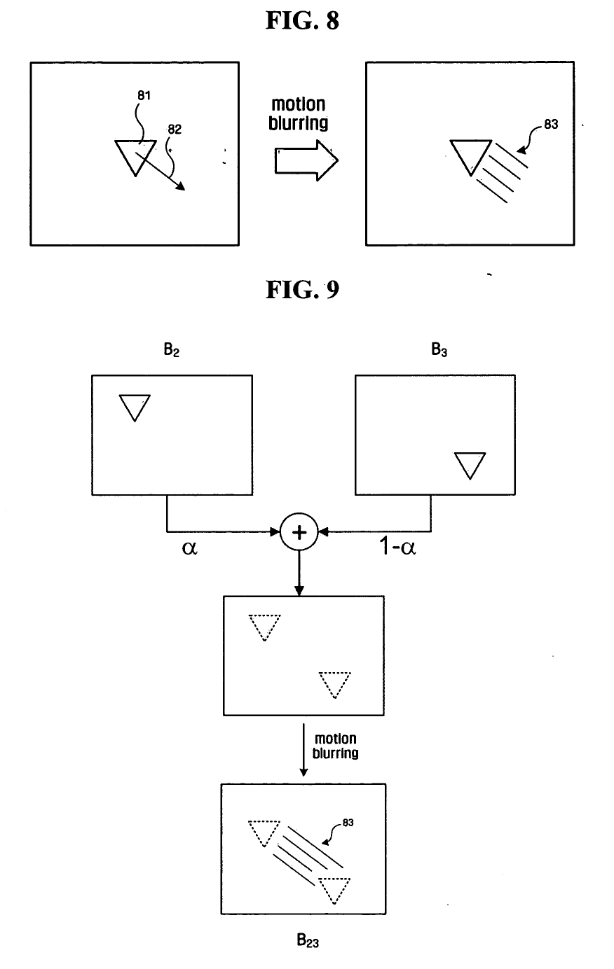

Meantime, by applying motion blurring to the frame after the B-frame composition operation, a more realistic frame can be generated. As shown in FIG. 8, in order to apply the motion blurring to a frame, an area 81, to which the motion blurring is to be applied, and a motion direction 82 should be defined first. The motion direction 82 means the direction that the specified area moves over time, which can be determined by a motion vector. The motion direction 82 may be the same direction as the motion vector or the opposite direction to the motion vector according to a frame reference direction.

If the application area 81 and the motion direction 82 are defined, motion blurring can be performed, and thus a blurred image 83 can be generated. During the motion blurring, the blurring strength may vary. Since the motion blurring is a technology that is widely used and can be easily adopted and used by those of ordinary skill in the art, its detailed algorithm has been omitted.

The motion blurring may be applied to frames having passed through the B-frame composition operation as shown in FIG. 9. In this case, it is preferable, but not necessary, that the motion blurring be applied between two moving objects.

In addition to the pixel-domain composition method, the use of the transform-domain blending method may be considered. In this case, in order to perform a faster transform than the cascaded pixel-domain transcoder, the use of the transform-domain transcoder is considered. If the frame composition is possible in the transform domain, the target bitstream can be directly generated during the transcoding without passing through a decoding process. In consideration of the distance motion-compensated by the motion vector in the transform-domain, the process of composing the B-frames can be applied as it is.

Overlapping-Frame Setting

Last, a method of displaying at an appropriate time the frame composed through the B-frame composition operation is required in the decoder. Using a frame re-display bit, which is supported in the MPEG-2 standard, the decoder can display at the appropriate time the respective frames of the bitstream generated according to the B composition mode, without receiving any additional information. In the case of the MPEG-2, the encoder can transfer the display policy of the composite frame B₂₃ to the decoder, using the “top_field_first” bit and the “repeat_first_field” bit of the frame coding extension.

The two bits as described above, in the case of using the field frame, indicate which field among upper and lower fields is to be first indicated, and the frequency of repetition of the first indicated field. In the case of a frame of a progressive sequence, how many times the corresponding frame is repeated is indicated by a combination of the two bits.

If the top_field_first bit recorded for a certain frame in a progressive sequence is “0” and the repeat_first_field bit is “0” (i.e., if the bit combination is “00”), the corresponding frame is displayed only once. If the bit combination is “01”, the corresponding frame is displayed twice, and if “11”, the corresponding frame is displayed three times.

If a GOP has the structure: {I, B₁, B₂, B₃, P, B₄, . . . }, and B₁, B₂ and B₃ are used to generate B₁₂₃, it is preferable, but not necessary, that the frame is transmitted at the B₁ position and is displayed three times. Accordingly, the encoder may set the top_first_field bit and the repeat_first_field bit of the frame B₁₂₃ to “1”, and transmit the bits to the decoder. The decoder, which has received the bits, confirms that the bit combination is “11”, and displays the frame B₁₂₃ three times. In other words, the decoder can continuously display the composite frame B₁₂₃ at a time when the original frames B₁, B₂ and B₃ were to be displayed.

In the same manner, the encoder may indicate the bit combination as “00”, so that the decoder can display the frame B₁₂₃ once at a time when the original frame B₁ was to be displayed. Also, the encoder may indicate the bit combination as “01”, so that the decoder can display the frame B₁₂₃ twice at a time when the original frames B₁ and B₂ were to be displayed.

In the case of applying the B-frame composition mode as described above to a video sequence in which the frame rate has already been increased through telecine technology (corresponding to a method of transforming a 24 frame rate movie into the 29.97 frame rate of the NTSC format (National Television Systems Committee)), it is preferable, but not necessary, to exclude the repeated B-frame from the frame dropping and the frame composition, in order to easily adjust the bit rate.

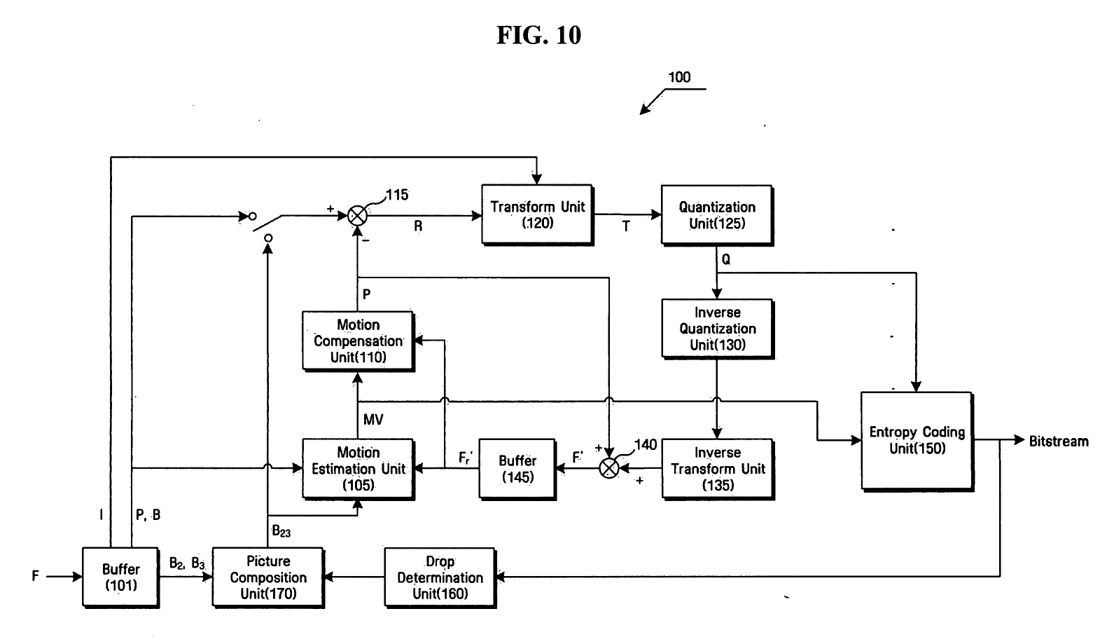

FIG. 10 is a block diagram illustrating the construction of a video encoder according to an exemplary embodiment of the present invention.

An input current frame F is temporarily stored in a buffer 101. If the frame F is an I-frame, it is provided to a transform unit 120, while if it is a P-frame or B-frame, it is provided to an adder 115 and a motion estimation unit 105. However, if the B-frame is a frame B₃ to be dropped or a frame B₂ to be composed, it is provided to a frame composition unit 170. In the description, the I-frame means a frame that is encoded without referring to another frame, and the P-frame or B-frame means a frame that is encoded with reference to another frame. Particularly, the B-frame is a frame that refers to two frames (previous and next frames).

A drop determination unit 160 determines frames to be dropped among a plurality of frames. For this, the drop determination unit 160 compares the bit rates in order to check whether the encoded GOP is in accord with the target bit rate. For this bit-rate comparison, the drop determination unit 160 receives feedback on the size of a bitstream generated by an entropy coding unit 150. In addition, in order to not exceed the target bit rate, the drop determination unit 160 selects B-frames to be dropped. If available bits remain due to the drop of the B-frames, the drop determination unit 160 can reallocate the bits to another frame.

The frame composition unit 170 generates a composite frame by obtaining a weighted sum of the frame B₃ determined to be dropped and the frame B₂ adjacent to the frame B₃. Two frames adjacent to the dropped frame may exist.

The weighted sum can be obtained by alpha blending expressed by Equation (1). In FIG. 10, it is exemplified that one frame is dropped and then two frames are composed. The weighted sum in the case of dropping two frames and then composing three frames can be obtained in the same manner by the alpha blending expressed by Equation (2). The alpha blending may be performed in a pixel domain, as exemplified in FIG. 10, or in a transform domain after the spatial transform is performed by the transform unit 120.

The frame composition unit 170 may additionally perform a motion blurring with respect to the obtained composite frame. In this case, the frame composition unit 170 selects a specified area of the composite frame, and performs the motion blurring according to a motion vector of the area. The motion blurring applied to the composite frame has been described with reference to FIGS. 8 and 9.

A composite frame B₂₃ generated by the frame composition unit 170 is provided to the motion estimation unit 105 and the adder 115.

The motion estimation unit 105 receives the P-frame, B-frame, or composite frame B₂₃, and produces a motion vector MV by performing motion estimation with respect to the input motion vector with reference to a neighboring reference frame. As the reference frame, the original image may be used (open-loop coding method) or a decoded image may be used (closed-loop coding method). FIG. 10 exemplifies the closed-loop coding method.

The motion estimation is performed using a block matching algorithm, which is widely used. The block matching algorithm estimates a displacement that corresponds to the minimum error as a motion vector by moving a given motion block in the unit of a pixel or a sub-pixel (e.g., ½ pixel or ¼ pixel) in a specified search area of the reference frame. The motion estimation may be performed using a motion block of a fixed size or using a motion block having a variable size according to a hierarchical variable size block matching (HVSBM) algorithm.

A motion compensation unit 110 performs motion compensation of a reference frame Fᵣ′ using the motion vector MV, and produces a predicted frame P. The predicted frame P is input to a subtracter 115.

The subtracter 115 produces a residual frame R by subtracting the corresponding predicted frame from the P-frame, B-frame or composite frame B₂₃, and provides the residual frame to the transform unit 120.

The transform unit 120 generates transform coefficients T by performing a spatial transform with respect to the residual frame R. The DCT (Discrete Cosine Transform), wavelet transform, or others may be used as the spatial transform method. Transform coefficients are produced by the spatial transform. In the case of using the DCT as the spatial transform method, DCT coefficients are obtained, and in the case of using the wavelet transform method, wavelet coefficients are obtained.

A quantization unit 125 quantizes the transform coefficients. The quantization means representing the transform coefficients expressed as real values by discrete values. For example, the quantization unit 125 performs the quantization by dividing the transform coefficients by specified quantization steps and rounding the resultant values off to the nearest integer

The results of quantization, i.e., quantization coefficients Q, are provided to the entropy coding unit 150 and an inverse quantization unit 130.

An inverse quantization unit 130 inversely quantizes the quantization coefficients Q. In the inverse quantization process, values that match indexes generated in the quantization process are restored by using the same quantization table as that used in the quantization process.

An inverse transform unit 135 performs an inverse transform on the results of the inverse quantization. Such inverse transform is performed through a method corresponding to that of the transform unit 120 of the video encoder, and may employ the inverse DCT transform, inverse wavelet transform or others. An adder 140 adds the result of the inverse transform to the predicted frame, and generates a restored frame F′.

A buffer 145 stores the results provided by the adder 140. Accordingly, the buffer 145 may store the restored current frame F′ and the pre-restored reference frame Fᵣ′ as well.

The entropy coding unit 150 performs lossless coding on the motion vectors MV estimated by the motion estimation unit 105 and the quantization coefficients Q provided by the quantization unit 125, and generates a bitstream. Huffman coding, arithmetic coding, variable length coding or others may be used as the lossless coding method.

The entropy coding unit 150 can record in the bitstream a flag for transferring the frequency of repetition of the composite frame to the decoder. As described above, the flag may be a combination of the top_first_field bit and the repeat_first_field bit.

As described above, FIG. 10 illustrates the construction of the video encoder 100, which implements the B-frame composite mode according to an exemplary embodiment of the present invention. The B-frame composite mode may be applied to the transcoder in addition to the video encoder 100. The transcoder includes the construction of FIG. 10 as it is, and further includes a video decoder connected to an input part of a buffer 101. Accordingly, in the case of the transcoder, the frame F that is inputted to the buffer 101 is not an original frame, but is a decoded frame.

Each component in FIG. 1 may be, but not limited to, a software or hardware component, such as a Field Programmable Gate Array (FPGA) or an Application Specific Integrated Circuit (ASIC), which performs certain tasks. A component may advantageously be configured to reside in an addressable storage medium and configured to execute on one or more processors. The functionality provided for in the components and modules may be combined into fewer components and modules or further separated into additional components and modules.

As described above, according to the exemplary embodiments of the present invention, even in the case of a video sequence in which scenes have severe variation, a constant bit rate can be maintained, and bits to be allocated to I-frames and P-frames can be sufficiently secured. Also, information of the deleted B frame is preserved by the composition, and thus it is possible to obtain a CBR stream having an improved subjective quality.

Accordingly, it is possible to provide a bitstream having an improved quality using a given bandwidth during a home-network or Internet transmission.

In addition, more stable CBR characteristics can be obtained by applying the method according to the exemplary embodiments of the present invention to a bit-rate transcoder adaptive to the available bandwidth.

Although the exemplary embodiments of the present invention have been described for illustrative purposes, those skilled in the art will appreciate that various modifications, additions and substitutions are possible, without departing from the scope and spirit of the invention as disclosed in the accompanying claims.

What is claimed is:

1. A video coding method comprising operations of:
(a) determining at least one frame to be dropped among a plurality of frames;
(b) generating a composite frame by obtaining a weighted sum of a frame adjacent to the at least one frame to be dropped and the at least one frame to be dropped; and
(c) generating a bitstream by encoding the generated composite frame.

2. The video coding method as claimed in claim 1, wherein the weighted sum is obtained by an alpha blending method.

3. The video coding method as claimed in claim 1, wherein operation (b) is performed in a pixel domain.

4. The video coding method as claimed in claim 1, wherein operation (b) is performed in a transform domain.

5. The video coding method as claimed, in claim 1, wherein the composite frame is represented by a following equation:
$${B}_{c} = \sum {α}_{n} {B}_{n} + ( 1 - \sum {α}_{n} ) \times {B}_{a} ,$$
where n is the number of the at least one frame to be dropped, αₙ is a weight value, B_{c} is the composite frame, Bₙ is the at least one frame to be dropped, and B_{α} is the adjacent frame.

6. The video coding method as claimed in claim 5, wherein, if the number of the at least one frame to be dropped is one, the weight value, which is α₁, is set to 0.5, wherein the composite frame is represented by: α₁×B₁+(1−α₁)×B_{α}.

7. The video coding method as claimed in claim 5, wherein, if the number of the at least one frame to be dropped is two, each of two weight values, which are α₁ and α₂, is set to ⅓, wherein the composite frame is represented by: α₁×B₁+α₂×B₂+(1−α₁−α₂)×B_{α}.

8. The video coding method as claimed in claim 1, wherein, if the number of the at least one frame to be dropped is two out of three frames to be successively displayed, the two frames to be dropped are first and third frames out of the three frames in the display order.

9. The video coding method as claimed in claim 1, wherein the at least one frame to be dropped is a B-frame.

10. The video coding method as claimed in claim 1, wherein operation (b) comprises:
obtaining the weighted sum of the at least one frame to be dropped and the frame adjacent to the at least one frame to be dropped; and
generating the composite frame by selecting a specific area of a frame generated by applying the weighted sum and performing a motion blurring according to a motion vector of the specific area.

11. The video coding method as claimed in claim 1, wherein operation (c) comprises:
obtaining a predicted frame of the generated composite frame;
generating a residual frame by subtracting the predicted frame from the composite frame;
generating transform coefficients by performing a spatial transform of the residual frame; and
quantizing the transform coefficients.

12. The video coding method as claimed in claim 1, wherein the bitstream includes a flag for notifying a decoder of frequency of repeated display of the composite frame.

13. A video transcoding method comprising operations of:
(a) decoding an input bitstream;
(b) determining at least one frame to be dropped among a plurality of frames generated as a result of decoding;
(c) generating a composite frame by obtaining a weighted sum of a frame adjacent to the at least one frame to be dropped and the at least one frame to be dropped; and
(d) generating another bitstream by encoding the generated composite frame.

14. A video encoder comprising:
a unit which determines at least one frame to be dropped among a plurality of frames;
a unit which generates a composite frame by obtaining a weighted sum of a frame adjacent to the at least one frame to be dropped and the at least one frame to be dropped; and
a unit which generates a bitstream by encoding the generated composite frame.

15. The video encoder as claimed in claim 14, wherein the weighted sum is obtained by an alpha blending method.

16. The video encoder as claimed in claim 14, wherein the unit which generates the composite frame generates the composite frame in a pixel domain.

17. The video encoder as claimed in claim 14, wherein the unit which generates the composite frame generates the composite frame in a transform domain.

18. The video encoder as claimed in claim 14, wherein the composite frame is represented by a following equation:
$${B}_{c} = \sum {α}_{n} {B}_{n} + ( 1 - \sum {α}_{n} ) \times {B}_{a} ,$$
where n is the number of the at least one frame to be dropped, αₙ is a weight value, B_{c} is the composite frame, Bₙ is the at least one frame to be dropped, and B_{α} is the adjacent frame.

19. The video encoder as claimed in claim 18, wherein, if the number of the at least one frame to be dropped is one, the weight value, which is α₁, is set to 0.5, wherein the composite frame is represented by: α₁×B₁+(1−α₁)×B_{α}.

20. The video encoder as claimed in claim 18, wherein, if the number of the at least one frame to be dropped is two, each of two weight values, which are α₁ and α₂, is set to ⅓, wherein the composite frame is represented by: α₁×B₁+α₂×B₂+(1−α₁−α₂)×B_{α}.

21. The video encoder as claimed in claim 14, wherein, if the number of the at least one frame to be dropped is two out of three frames to be successively displayed, the two frames to be dropped are first and third frames out of the three frames in the display order.

22. The video encoder as claimed in claim 14, wherein the at least one frame to be dropped is a B-frame.

23. The video encoder as claimed in claim 14, wherein the unit which generates the composite frame comprises:
a unit which obtains the weighted sum of the at least one frame to be dropped and the frame adjacent to the at least one frame to be dropped; and
a unit which generates the composite frame by selecting a specific area of a frame generated by applying the weighted sum and performing a motion blurring according to a motion vector of the specific area.

24. The video encoder as claimed in claim 14, wherein the unit which generates the composite frame comprises:
a unit which obtains a predicted frame of the generated composite frame;
a unit which generates a residual frame by subtracting the predicted frame from the composite frame;
a unit which generates transform coefficients by performing a spatial transform of the residual frame; and
a unit which quantizes the transform coefficients.

25. The video encoder as claimed in claim 14, wherein the bitstream includes a flag for notifying a decoder of frequency of repeated display of the composite frame.

26. A video transcoder comprising:
a unit which decodes an input bitstream;
a unit which determines at least one frame to be dropped among a plurality of frames generated as a result of the decoding;
a unit which generates a composite frame by obtaining a weighted sum of a frame adjacent to the at least one frame to be dropped and the at least one frame to be dropped; and
a unit which generates another bitstream by encoding the generated composite frame.
